(19) United States
(12) Patent Application Publication
(10) Pub. No.: US 2023/0080884 A1
(43) Pub. Date: Mar. 16, 2023

(54) FUEL CELL SYSTEM

(71) Applicant: HOERBIGER ANTRIEBSTECHNIK HOLDING GMBH, Schongau (DE)

(72) Inventors: Jochen SCHAIBLE, Schongau (DE); Felix ROTHE, Schongau (DE); Clemens POTESCHIL, Schongau (DE); Robert NOTZ, Schongau (DE); Georg HOLZHEU, Schongau (DE); Aleksandar PERICEVIC, Schongau (DE)

(21) Appl. No.: 17/990,198

(22) Filed: Nov. 18, 2022

Related U.S. Application Data
(63) Continuation of application No. PCT/EP2021/064346, filed on May 28, 2021.

(30) Foreign Application Priority Data
May 28, 2020 (DE) 102020114410

(51) Int. Cl. H01M 8/04089; F02M 63/00; F04F 5/16; F04F 5/48

(52) U.S. Cl. CPC H01M 8/04097; F02M 63/0017; F02M 63/0077; F04F 5/16; F04F 5/48; H01M 8/04753

(57) ABSTRACT

A fuel cell system is provided having a fuel cell and a jet pump control valve unit connected to an anode chamber with an intake connection and a pressure connection. A fuel gas control valve connecting a fuel gas source and the jet pump has a valve seat with a first sealing surface and at least two through-flow channels, and a moveable valve body with a second sealing surface. The valve body can be moved into a blocking position and a through-flow position using a valve body actuator. The sealing surfaces rest on one another in a common sealing plane and form a seal in the blocking position. A stroke gap is formed between the sealing surfaces in the through-flow position. The first or second sealing surface is arranged on a raised sealing level. A volume flow of a drive jet can be controlled by the valve body actuator.

### CROSS REFERENCE TO RELATED APPLICATIONS

This application is a continuation under 35 U.S.C. § 120 of International Application PCT/EP2021/064346, filed May 28, 2021, which claims priority to German Application No. 102020114410, filed May 28, 2020, the contents of each of which are incorporated by reference herein.

### FIELD OF THE INVENTION

The present invention relates to a fuel-cell system, comprising a fuel cell having an anode chamber and a cathode chamber as well as, connected with a suction port and with a pressure port on the anode chamber, and serving for recirculation of an anode gas and metered charging of the anode chamber with fuel gas, a jet-pump control-valve unit having a jet pump and a fuel-gas control valve, wherein the fuel-gas control valve is connected fluidically between a fuel-gas source and the jet pump.

### BACKGROUND

By means of a fuel cell, it is possible to generate electrical current by the fact that, typically, a fuel gas (e.g. hydrogen or a hydrogen-containing gas mixture) delivered to the anode chamber reacts chemically with an oxygen-containing gas/gas mixture (e.g. ambient air) delivered to the cathode chamber, with formation of a reaction product (e.g. water). The said anode chamber is usually separated from the cathode chamber by an electrolyte membrane. The reaction product formed during the chemical reaction occurs mostly in the cathode chamber. Due to leaks within the fuel cell as well as undesired side reactions, however, condensation water and foreign gases (e.g. nitrogen) can also accumulate in the anode chamber and impair the function of the fuel cell. Therefore technical devices (e.g. drain valves, flush valves) are usually provided in order to remove condensation water and foreign gases from the anode chamber.

In order to ensure an adequate supply of the anode with fuel gas (e.g. hydrogen), this is usually delivered over-stoichiometrically, and the anode gas is exhausted via the suction port of the anode chamber and then returned (recirculated) to the anode chamber via the pressure port of the anode chamber. This recirculation of the anode gas can be achieved both by an externally (e.g. electrically) driven circulating blower and internally by the jet pump driven by the pressurized fuel gas itself.

This pressurized fuel gas usually enters the jet pump through a propulsion nozzle, while creating a propulsion jet in a mixing chamber of the jet pump. Due to the phenomenon of momentum exchange, anode gas is entrained by the propulsion jet and is thereby sucked along and conveyed. The ratio of the volume flows of recirculated anode gas to propulsion gas employed for the purpose is known as recirculation rate. This fluctuates in dependence on the mode of operation of the fuel-cell system; usually it increases the further the operating point of the fuel-cell system is shifted in the direction of lower partial load and can assume values of 10 and more, especially during operation at low partial load.

Compared with an externally driven circulating blower, a jet pump does not have to be driven by application of (electrical) energy, thus favoring energy efficiency of the fuel-cell system. In addition, jet pumps are characterized by long useful life and high reliability, since moving parts (which are susceptible to malfunctions) can be dispensed with. However, the use of a jet pump is typically also associated with restrictions on operation of the fuel cell in partial-load mode, since a jet pump typically develops its pumping effect only when a certain minimum propulsion-gas volume flow is exceeded.

Fuel-cell systems of the type mentioned in the introduction—in which jet pumps are therefore used for recirculation of the anode gas—have been known for many years. They are described, for example, not only in DE 10 2011 105 054 A1 and DE 10 2010 043 618 A1, but also, for example, in EP 2 565 970 A1, U.S. Pat. No. 9,029,032 B2, DE 10 2011 086 917 A1, DE 10 2011 114 797 A1, US 2019/0148746 A1 and US 2007/0248858 A1; they are also already in service, and specifically both in stationary applications (e.g. as cogeneration systems, as network-independent current generators) and in mobile applications (e.g. in motor vehicles, ships, aircraft). Especially for mobile applications, particular focus is placed on requirements such as long useful life, reliability even under extreme service and environmental conditions, partial-load capacity, low noise emission and high energy efficiency.

Detailed aspects of such fuel-cell systems are subject matter of various publications. For example, DE 10 2011 114 797 A1, already mentioned in the foregoing, relates to (intermittent) heating of the propulsion-jet nozzles of the jet pump; and DE 10 2018 200 314 A1 relates to a jet-pump unit intended for use in vehicles with fuel-cell drive having a specific metering valve serving for control of hydrogen or another gas.

Extensive prior art exists for fuel-cell technology in the broader sense, i.e. going beyond the fuel-cell systems in question here. For example, DE 10 2015 224 333 A1 relates to a method for determining the anode integrity during operation of a fuel-cell vehicle, wherein anode leak tests, which in particular do not act negatively on the vehicle performance, during operation of the vehicle, are proposed on the basis of hydrogen flow into a fuel cell. And DE 10 2010 043 614 A1 discloses a proportional valve that is used to control the delivery of hydrogen gas to the fuel cell of a vehicle having fuel-cell drive and that is suitable for the purpose.

### SUMMARY

An object of the present invention is to provide a fuel-cell system of the type mentioned in the introduction that is characterized by an improved, particularly pronounced practical utility, especially with regard to useful life, partial load capacity and energy efficiency.

This object is achieved by a fuel-cell system of the type mentioned in the introduction having the following synergetically acting features:
The fuel-gas control valve comprises a valve seat having a first sealing face with at least two passage ducts and a movable valve body having a second sealing face.
The valve body can be moved into a blocking position and a passing position by means of a valve-body actuator, wherein the first sealing face and the second sealing face bear on one another in a common sealing plane and form a seal with one another in the blocking position, while a stroke gap is formed between the first sealing face and the second sealing face in the passing position.
The first sealing face and/or the second sealing face is disposed on a raised sealing plateau.
A valve seat surface in the region of the first sealing face and/or a valve body surface in the region of the second sealing face has/have an average peak-to-valley height of at most 1 μm.
The volume flow of a propulsion jet that can be generated by means of a propulsion nozzle of the jet-pump control-valve unit can be controlled by pulse-width-modulated urging of the valve-body actuator.

Due to the pulse-width-modulated pressurization of the valve-body actuator, the volume flow of the propulsion jet is controlled not continuously but instead discontinuously in such a way that blocking intervals without volume flow (in which the valve body is in the blocking position) alternate with passing intervals of high volume flow (in which the valve body is in passing position). By adaptation of the lengths of the blocking intervals and passing intervals (“pulse widths”), the mean volume flow averaged over a longer duration can be controlled.

In the process, the pulsating propulsion jet corresponding to the sequence of blocking and passing intervals causes the jet pump to generate a correspondingly pulsating mixed-gas stream of recirculated anode gas and (fresh) fuel gas to enter the anode chamber (through the pressure port) and a correspondingly pulsating anode-gas stream to be sucked out of the anode chamber (through the suction port).

Due to the synergetic interaction of the inventive features, an extremely steeply rising and falling pulsed flow change (“pulse surge”) can be imposed on the propulsion jet (during the occurring passing intervals), whereby a series of surprising advantages is made possible that increase the practical utility of the inventive fuel-cell system.

Firstly, the pulse surge of the propulsion jet can cause the anode-gas stream to be sucked in more or less surge-like manner, but in equal measure, from the anode chamber through the suction-tube port into the jet pump. This pulsating, surge-like suction can contribute to sucking a greater volume of anode gas into the jet pump (in comparison with more continuous suction). Thus the recirculation rate can be increased, which is conductive to the partial load capacity of the fuel-cell system. Beyond this, the surge-like suction also favors the removal of (undesired) condensation water present in the anode chamber, since this, due to the surge-like suction, is entrained to a greater extent by the anode gas and prevented from settling on surfaces in the anode chamber. Both effects can be quite particularly manifested by utilization of possible vibrational and resonance phenomena.

Secondly, the pulse surge of the propulsion jet can cause the mixed-gas stream to flow in comparable surge-like manner through the pressure port into the anode chamber, whereby intermixing of the gas in the anode chamber can be promoted and fluidic dead zones can be reduced. Both improve the supply or the charging of the anode with fuel gas and thus help to increase the effectiveness, energy efficiency and useful life.

The inventive features as well as their interaction are jointly aimed at permitting, in the propulsion gas and mixed-gas streams, a sequence, as sharply defined as possible, of pulsed flow changes corresponding to the repeating pattern resulting from the pulse-width-modulated operation of the valve-body actuator:

In the process, sealing without elastic deformation of valve body and/or valve seat can be achieved in the fuel-gas control valve due to the surface qualities present at the valve-body surface as well as the valve-seat surface. A hard-sealing construction of the fuel-gas control valve can be achieved to this extent. Thereby—in contrast to “soft-sealing” valves, i.e. especially such having elastomeric contact at valve seat and/or valve body—it can be ensured that any movement of valve body and valve seat away from one another results immediately and directly in lifting of the valve body from the valve seat and thus the flow of fuel gas is released immediately and directly—and so an elastic deformation of the valve body and/or of the valve seat that occurred before, i.e. during previous closing of the valve, does not have to be first reset before the valve body and the valve seat lift apart from one another. This favors the achievability of a surge-like pulsed flow change.

Beyond this, by the fact that the valve body and the valve seat cannot be stressed to the point of deformation during the sealing process, their mechanical stress relevant for material-fatigue phenomena can be reduced and thus their useful life can be prolonged. This—together with its very high number of valve-body movements that lead to sealing contact—benefits the pulse-width-modulated mode of operation of the fuel-gas control valve. Even some minor fuel-leakage flows associated with this deformation-free (“hard”) type of sealing during the blocking intervals would be acceptable in view of the quite considerable advantages achievable due to the invention.

For achievement of the said hard sealing, at least one of the two sealing partners (valve body or valve seat) at the sealing surface in question has an average peak-to-valley height of at most 1 μm, preferably at most 0.25 μm, particularly preferably at most 0.1 μm. If both sealing partners have a comparably hard sealing surface, especially because similar material is used at both sealing surfaces, the said surface quality is true for both sealing partners. In contrast, if one of the two sealing partners is harder at its sealing surface than the other sealing partner is at its sealing surface, for example because the valve body has a valve-body surface consisting of steel while the valve seat has a valve-seat surface consisting of plastic, it is harmless for the surface quality of the less hard sealing surface (before initial operation of the fuel-gas control valve) to be poorer (e.g. approximately by one order of magnitude) than that of the harder sealing surface. Thus, for example, it is possible—without negative effects on the function—to use a valve seat made from filled plastic (especially PEEK; see below), wherein its surface quality is characterized by an initial average peak-to-valley height of at most 10 μm, preferably at most 2.5 μm, particularly preferably at most 1 μm. This is the case because, in the running-in phase, smoothing of the sealing surface of the less hard sealing partner by the harder of the two sealing partners takes place within a short time, favored by the high-frequency mutual impacting of the two sealing partners as a result of the pulse-width-controlled operation of the fuel-gas control valve. The “average peak-to-valley height” mentioned in the foregoing is the average peak-to-valley height Rz, as defined and measured according to DIN EN 4287 and DIN EN 4288.

This cited high surface quality at valve-body surface or valve-seat surface can be achieved by machining them by means of fine mechanical surface treatment, such as, for example, lapping, honing and polishing. Examples of materials for the valve body and the valve seat are in particular metals as well as plastics highly filled with mineral substances, carbon or glass fibers, especially polyether ether ketones (PEEK), polyphenylsiloxanes (PPS), polyether imides (PEI) and polyphthalamides (PPA).

The arrangement of at least one sealing face on a raised sealing plateau that is projecting relative to the adjoining end-face regions of the element in question (valve seat or valve body) likewise has considerable influence on the enablement of a surge-like change of pulsed flow of the propulsion jet. In this way it can be ensured that, when the fuel-gas control valve is closed (blocking position), fuel gas under pressure from the fuel-gas source accumulates in a pressure chamber, which extends, clamped by the raised sealing plateau, between the mutually facing end faces of valve seat and valve body. Thus, in blocking position of the valve body, fuel gas under pressure and thus correspondingly compressed is directly present at the shortest possible distance from the cooperating sealing faces and, when the fuel-gas control valve is opened (movement of the valve body into passing position), is able to expand in surge-like manner into the passage ducts. In this way, an improvement of the surge-like propulsion-jet formation can be achieved in that, when the two sealing faces are raised from one another, fuel gas under adequate pressure is immediately and directly available to flow into the at least two passage ducts and thus to contribute to a surge-like flow buildup.

The foregoing effect in turn permits operation of the fuel-gas control valve with an extremely short stroke of the valve body. In typical application situations, a stroke of less than 0.5 mm is sufficient. In a particularly preferred configuration, the stroke of the valve body is less than 0.3 mm, for example 0.2 mm. Such short strokes act positively on the operating behavior. For particularly advantageous operating behavior of the fuel-gas control valve, the axial extent of the pressure chamber (see above) formed between the mutually facing end faces of valve seat and valve body preferably amounts to at least 1.5 times, particularly preferably at least 3 times the valve-body stroke.

The present invention utilizes the knowledge that the intermittent propulsion jet of importance for the present inventive concept, with surge-like buildup and decay of the propulsion-gas flow, can be achieved for the first time by the interaction of the inventive features.

In a first further development of the invention, the first sealing face is disposed on the raised sealing plateau and is formed by at least one annular face, in which at least two passage ducts discharge respectively into a passage-duct outlet. Advantageously, these passage-duct outlets are of circular, oval, triangular or trapezoidal shape. In this way, it can be ensured that the pressure chamber extends both inside and outside the annular face between valve body and valve seat and so, in the course of opening of the valve, fuel gas is able to expand and flow into the at least two passage ducts from two sides, thus favoring surge-like buildup of the propulsion jet.

In this connection, it is quite particularly preferred for a reference circumference or a sum of reference circumferences of the at least one annular face to be at least 60 times, preferably at least 80 times, particularly preferably at least 100 times larger than the stroke gap in passing position. The reference circumference of such an annular face is defined as the arithmetic mean of the outer circumference and inner circumference of the annular face in question. In this way, it can be ensured that the flow cross section decisive for fuel-gas flow is already reached in the passing position after particularly small relative movement of the valve body relative to the valve seat. Minimization of the movement distances simultaneously reduces the necessary actuation time as well as the actuation energy to be consumed and acts particularly advantageously on the movement-distance-dependent closing of the component part and thus on the useful life of the fuel-gas control valve.

Alternatively, in a second further development of the invention, the first sealing face can be disposed on the raised sealing plateau and be formed by at least two face portions (not joined to one another in the sealing plane), in which respectively (at least) one passage duct discharges into a passage-duct outlet, wherein the at least two face portions are preferably respectively of circular, oval, triangular or trapezoidal shape. In this way, it can be ensured that the pressure chamber extends annularly outside a respective face portion between valve body and valve seat and so, in the course of opening of the valve, fuel gas is able to expand and flow into the respective passage duct from all sides, thus favoring surge-like buildup of the propulsion jet.

In this connection, it is particularly favorable for a sum of the circumferences of the at least two face portions to be at least 150 times, preferably at least 250 times, particularly preferably at least 350 times larger than the stroke gap in passing position. In this way, i.e. if the cumulative circumferential lengths (relative to the valve-body stroke) are correspondingly very large, it can be ensured—as already explained analogously in the foregoing—that the flow cross section decisive for fuel-gas flow is already reached in the passing position after particularly small relative movement of the valve body relative to the valve seat and that the advantages permitted thereby are achieved particularly perceptibly.

Another further development of the inventive fuel-cell system is characterized in that the valve-body actuator comprises a flux concentrator and an armature coupled with the valve body, wherein, in the passing position, an air gap is formed between the armature and the flux concentrator. Due to the air gap, it can be ensured that, in passing position, the armature does not come into contact with the flux concentrator and “stick” to it (induced by magnetic and/or surface forces), which could at least make movement of the valve body back into the blocking position more difficult and slower and thus negatively affect the dynamics of movement of the valve body.

According to another further development, the valve body or an armature that may be provided on the valve-body actuator is stopped in the passing position against at least one stop element, which is designed to be particularly elastic and/or noise-reducing. In this way—in the case of the previously discussed further improvement—it can be ensured simply and reliably that the flux concentrator and the armature cannot come into contact with one another in the passing position. Beyond this, given appropriate construction of the stop element, it can generally be ensured, especially by its elastic and/or noise-reducing construction, that the noise emission of the fuel-gas control valve is reduced when the passing position is reached and thus the practical utility of the fuel-cell system is increased. The useful life of the fuel-gas control valve also benefits from this feature.

Another further development of the invention is characterized in that the valve body is able to move along a movement axis into the blocking position and passing position, wherein the fuel gas can flow into the fuel-gas control valve in a manner transverse to the movement axis and can flow out of the fuel-gas control valve along the movement axis. Thus it can be ensured that the fuel-gas stream is deflected only by approximately 90 degrees while flowing through the fuel-gas control valve, and so a pressure loss associated with greater deflection can be avoided, thus benefiting the surge-like buildup of the propulsion jet.

According to another further development, a negative influence on the surge-like change of pulsed flow of the propulsion jet by frictional effects developing between the inflow of fuel gas into the passage ducts and the outflow of the propulsion jet from the propulsion nozzle can be minimized by providing the propulsion nozzle with a propulsion-nozzle outlet, wherein the distance between the propulsion-nozzle outlet and the first sealing face is at most 160 times, preferably at most 130 times, larger than the stroke gap when the fuel-gas control valve is open. On the other hand, in order to achieve smooth acceleration of the propulsion gas in the propulsion nozzle, the said distance should also not be too small. Preferably it is at least 70 times, preferably 100 times larger than the stroke gap when the fuel-gas control valve is open. Very good operating properties are achieved in case of compliance with the foregoing dimensions.

According to another further development of the invention, the valve body is able to move along a movement axis into the blocking position and the passing position, wherein the valve body has, on its end face turned toward the valve seat, at least one recess, constructed in particular as a blind hole or annular groove, which is in fluidic communication with at least one inflow duct extending transversely relative to the movement axis as far as the periphery of the valve body. In this way it can be ensured that fuel gas is able to reach the pressure chamber through the inflow duct (or the inflow ducts) and the recess and, when the fuel-gas control valve is open (passing position of the valve body), is able to flow further to the passing ducts. Ideally, a double supply of the pressure chamber with fuel gas is achieved on the one hand by the at least one inflow duct as well as the recess and on the other hand with lateral flow around the valve body.

According to another further development, an inventive fuel-cell system with quite particularly compact fuel-gas control valve can be achieved when the fuel-gas control valve comprises a sleeve-like valve housing, which receives the valve seat, the valve body and the valve-body actuator. For this purpose, the valve body is preferably guided movably by the valve housing along a movement axis between the blocking position and the passing position and in the process is in contact therewith inside an annular contact region of the valve housing that acts as the guide. Furthermore, preferably at least one inflow opening (for the fuel gas) extending transversely relative to the movement axis is formed in a portion of the valve housing starting from the contact region and turned toward the valve seat, and at least one compensating opening (for the fuel gas) extending transversely relative to the movement axis is then formed in a portion of the valve housing starting from the contact region and turned away from the valve seat. Due to the arrangement of the at least one inflow opening and the at least one compensating opening on different sides of the valve body in the valve housing, it can be ensured that fuel gas having identical pressure is present at the valve body on the compensating-opening side and on the inflow-opening side, so that the corresponding pressing forces on the valve body compensate for one another (pressure balance). This pressure balance permits rapid and energy-saving movability of the valve body along the movement axis.

Quite particularly preferably, the valve body is provided for this purpose with a sliding ring, by means of which the valve body is guided in the valve housing and is in contact with the annular contact region of the valve housing. In this case, a “floating bearing” of the valve body can be achieved by the sliding ring, thus ensuring that the valve body is aligned on the valve seat in blocking position, which benefits the tightness of the seal between valve body and valve seat.

Aspects of the present invention are manifested recognizably in the j et-pump control-valve unit. Against this background, the Applicant reserves the right to seek separate protection for precisely this isolated unit.

Although it is immediately obvious to a person skilled in the art even without special mention and against the background of his professional expertise, it should be stated explicitly here that the individual features of the further developments described in the foregoing can also be achieved separately from other individual features of the respective further development and can be combined with individual features of other further developments.

### BRIEF DESCRIPTION OF THE DRAWING

In the following, several exemplary embodiments of the invention will be explained in more detail on the basis of the drawing, wherein

FIG. 1 shows a schematic diagram of an inventive fuel-cell system,

FIG. 2 shows an axial section of a jet-pump control-valve unit of an inventive fuel-cell system,

FIG. 3 shows an enlarged axial section of the fuel-gas control valve of the jet-pump control-valve unit according to FIG. 2,

FIGS. 4a and 4b show the valve body of the fuel-gas control valve according to FIG. 3 in a side view (FIG. 4a) as well as a radial section (FIG. 4b),

FIGS. 5a to 6b show two different embodiments of a valve seat of an inventive fuel-cell system in respectively a plan view (FIGS. 5a, 6a) as well as an axial section (FIGS. 5b, 6b) and

FIG. 7 shows sections of plan views of four further different valve seats of inventive fuel-cell systems.

### DETAILED DESCRIPTION OF THE PREFERRED EMBODIMENTS

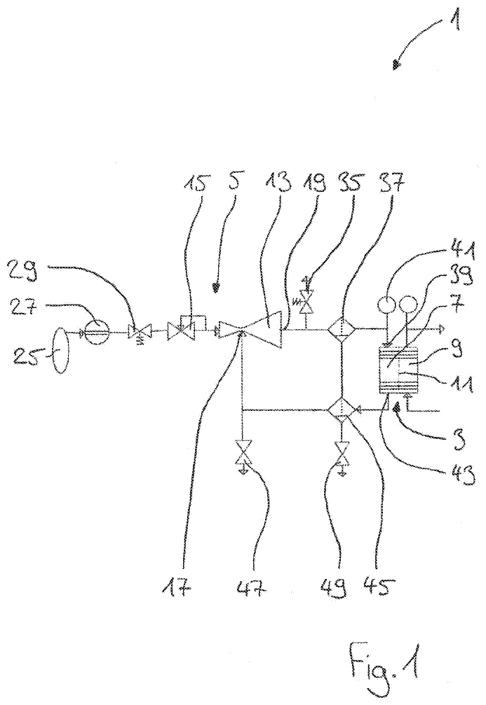

FIG. 1 schematically shows an inventive fuel-cell system 1, which comprises a fuel cell 3 and a jet-pump control-valve unit 5. Fuel cell 3 has, in conventional manner, an anode chamber 7, a cathode chamber 9 and an electrolyte membrane 11 separating anode chamber 7 and cathode chamber 9 from one another.

Jet-pump control-valve unit 5 comprises a jet pump 13 and a fuel-gas control valve 15, is connected via a suction port 17 and a pressure port 19 to anode chamber 7 and serves for recirculation of an anode gas as well as for metered charging of anode chamber 7 with fuel gas.

For this purpose, the fuel gas present under high pressure in fuel source 25 first passes an opened shutoff valve 27, before its pressure is reduced in a pressure regulator 29 and the fuel gas flows into fuel-gas control valve 15. Under control of the fuel-gas control valve, the fuel gas then flows into jet pump 13, where—in known manner—it entrains anode gas, which is sucked through suction port 17 and mixed with the (fresh) fuel gas to produce mixed gas. The mixed gas exits jet pump 13 through pressure port 19 and flows past safety valve 35 and through an (optional) first condensate separator 37, before it flows into anode chamber 7 of fuel cell 3 through an anode-chamber inlet 39. In the region of anode-chamber inlet 39, state parameters of the mixed gas (e.g. temperature, pressure, mixing ratio) relevant to control and operation are recorded by means of a sensor 41. The anode gas sucked out of anode chamber 7 through an anode-chamber exit 43 passes a (second) condensate separator 45 used for separation of condensation water and flows past a flush valve 47, which permits removal of foreign gases (e.g. nitrogen) accumulated in the anode chamber. Condensation water collected in the first condensate separator 43 or second condensate separator 45 if such are provided can be drained via a condensate drain valve 49. To the foregoing extent, the exemplary embodiment illustrated in the drawing is based on prior art sufficiently known to the person skilled in the art, and so further explanations are not needed.

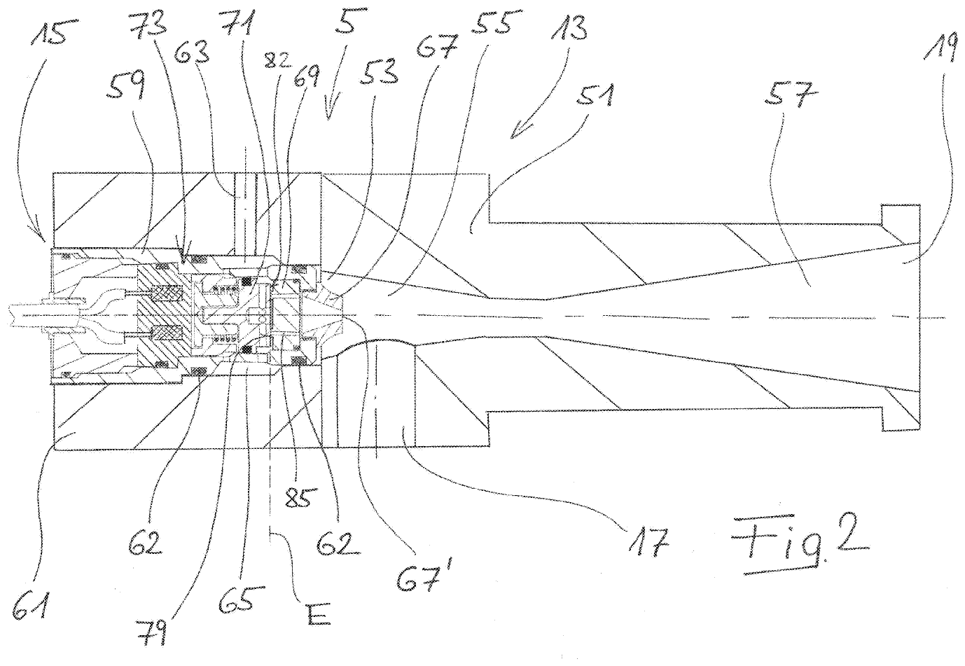

FIG. 2—which is partly not to scale for reasons of illustration of details—represents, in axial section, a jet-pump control-valve unit 5 of an inventive fuel-cell system 1 comprising a fuel-gas control valve 15 as well as a jet pump 13. Jet pump 13 has a jet-pump housing 51, in which a suction port 17, a pressure port 19 as well as a propulsion-jet port 53 are provided and which forms a mixing chamber 55 as well as a diffusor region 57. Since the jet-pump control-valve unit is based to this extent on prior art sufficiently known to the person skilled in the art, further explanations are unnecessary.

Fuel-gas control valve 15 comprises a sleeve-like valve housing 59, a valve seat 69, a valve body 71 and a valve-body actuator 73, and is inserted into a valve receptacle 61 receiving fuel-gas control valve 15 and directly adjoining jet-pump housing 51. Valve housing 59 is sealed relative to valve receptacle 61 by means of two O-rings 62. Valve receptacle 61 and jet-pump housing 51 could also be constructed in one piece, although they are not shown in such a manner in the drawing.

A fuel-gas port 63, via which fuel-gas source 25 is in fluidic communication with an annular fuel chamber 65 formed between valve receptacle 61 and valve housing 59, is provided in valve receptable 61. (In practice, the fuel-gas port 63 illustrated in the section plane for reasons of clarity is oriented not in this way but instead perpendicular to the section plane—and to suction port 17.)

A propulsion nozzle 67 projecting through propulsion-jet port 53 into mixing chamber 55 of jet pump 13 adjoins valve housing 59 on the jet-pump side. This propulsion nozzle 67 has a propulsion-nozzle outlet 67′. Fuel gas, which flows through fuel-gas port 63 into annular fuel chamber 65 and passes this when fuel-gas control valve 15 is open, then flows through propulsion nozzle 67 generating a propulsion jet into mixing chamber 55 of jet pump 13. There, the propulsion jet entrains anode gas sucked through suction port 17 and together with this enters diffusor region 57. The volume flow of the propulsion jet that can be generated by means of propulsion nozzle 67 of jet-pump control-valve unit 5 can be controlled by pulse-width-modulated urging of valve-body actuator 73. Alternatively to the embodiment illustrated in the drawing, propulsion nozzle 67 could also be constructed in one piece with valve housing 59 or jet-pump housing 51.

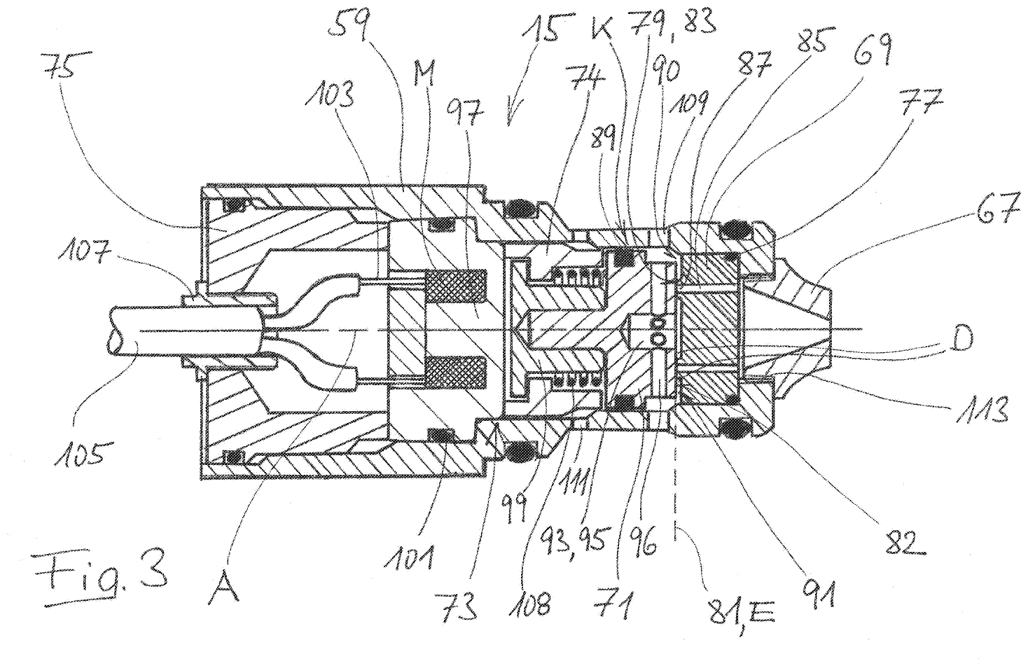

FIG. 3—which again is partly not to scale for reasons of illustration of details—represents fuel-gas control valve 15 of jet-pump control-valve unit 5 according to FIG. 2 (together with propulsion nozzle 67 screwed into valve housing 59) in an enlarged axial section. Valve seat 69, valve body 71, valve-body actuator 73, a stop element 74 and a valve cover 75 are received in sleeve-like valve housing 59.

Valve seat 69, sealed by means of an O-ring 77 relative to valve housing 59 and made from highly-filled PEEK, has a first sealing face 79 on its end face 90 turned toward valve body 71. This first sealing face 79 is disposed on a raised sealing plateau 81 projecting relative to the adjoining regions of end face 90 and is formed by eight circularly constructed face portions 83 (of which only two are visible in FIG. 3). In each face portion 83, respectively one passage duct 85 discharges into a passage-duct outlet 87. In the region of first sealing face 79, the valve-seat surface has an average peak-to-valley height Rz of approximately 2.5 μm (as measured originally, i.e. before initial operation of the fuel-gas control valve).

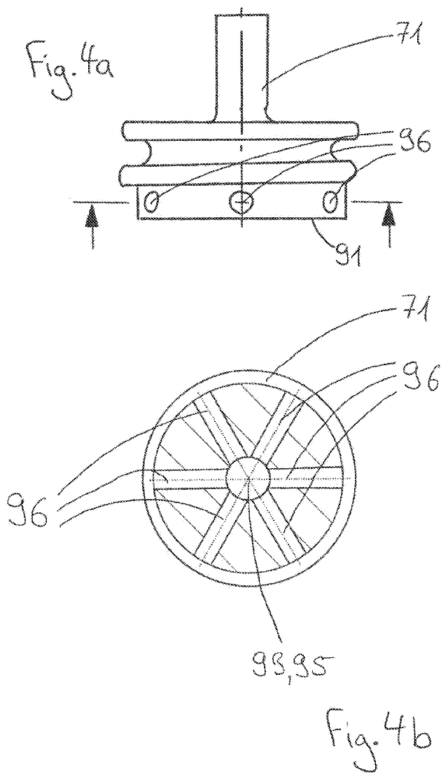

Valve body 71, made of steel, comprises a sliding ring 89 and on its end face 91 turned toward valve seat 69 has a second sealing face 82 as well as a recess 95 constructed as a blind hole 93, which is in fluidic communication with six inflow ducts 96 extending as far as the periphery of valve body 71 (see also FIGS. 4a and 4b). In the region of second sealing face 82, the valve-body surface has an average peak-to-valley height of approximately 0.25 μm.

Valve-body actuator 73 comprises an electromagnet M, a flux concentrator 97 and an armature 99 coupled with valve body 71. Flux concentrator 97 is sealed relative to valve housing 59 by means of an O-ring 101. Electromagnet M is joined via two contact points 103 with a cable 105, which is guided outward through a bushing 107 penetrating valve cover 75.

By means of valve-body actuator 73 as well as spring 108—braced on one side against valve body 71 and on the other side against stop element 74—the unit comprising armature 99 and valve body 71 can be moved along a movement axis A into a blocking position as well as a passing position, wherein, in the blocking position (as illustrated in FIG. 3), first sealing face 79 and second sealing face 82 bear on one another in a common sealing plane E and are sealed relative to one another, whereas, in the passing position (not illustrated), valve body 71—raised from valve seat 69—is stopped against stop element 74 and a stroke gap is formed between first sealing face 79 and second sealing face 81. For this purpose, valve body 71 is guided by means of sliding ring 89 through valve housing 59 and inside an annular contact region K of valve housing 59 is in contact with valve housing 59.

Valve housing 59 has eight inflow openings 109, eight compensating openings 111 and one outflow opening 113, wherein respectively only two inflow openings 109 and two compensating openings 111 are visible in FIG. 3. These inflow openings 109 are formed in a portion of valve housing 59 starting from contact region K and extending transversely relative to movement axis A in a manner turned toward valve seat 69; in contrast compensating openings 111 are formed in a portion of valve housing 59 starting from contact region K and extending transversely relative to movement axis A in a manner turned away from valve seat 69.

If fuel-gas control valve 15 is closed, valve body 71 is therefore in blocking position, and so fuel gas is able to accumulate in a pressure chamber D, which extends, clamped by raised sealing plateau 81, between the mutually facing end faces 90, 91 of valve seat 69 and valve body 71. Thus pressure chamber D can be supplied with fuel gas on the one hand by inflow ducts 96 as well as recess 95 formed as blind hole 93 and on the other hand with lateral flow around valve body 71. Thus, in blocking position of valve body 71, fuel gas under pressure and thus correspondingly compressed is directly present at the shortest possible distance from cooperating sealing faces 79, 82 and, when fuel-gas control valve 15 is opened, is able to expand into passage ducts 85, in order then to flow through outflow opening 113 out of fuel-gas control valve 15 along movement axis A.

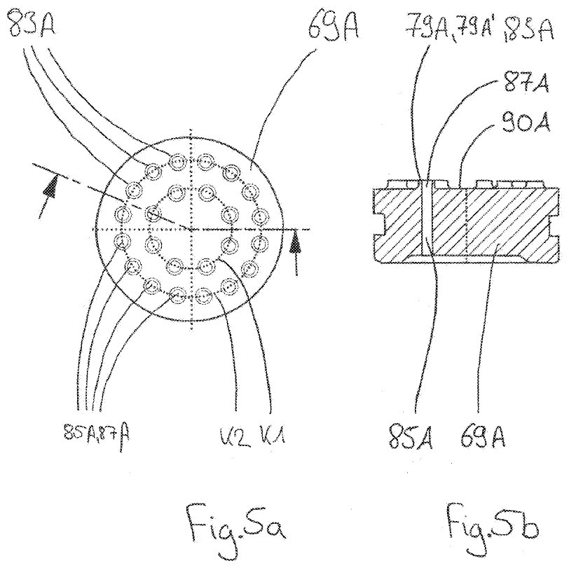

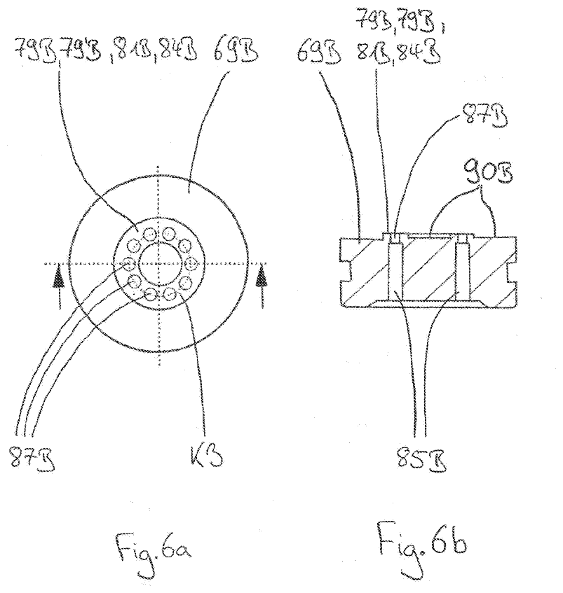

FIGS. 5a, 5b and FIGS. 6a, 6b respectively show a valve seat 69A, 69B of two further embodiments of inventive fuel-cell system 1 in a plan view as well as an axial section.

Valve seat 69A according to FIGS. 5a and 5b—again made from highly filled PEEK—has a first sealing face 79A, which is disposed on a raised sealing plateau 81A projecting relative to adjoining end-face regions 90A. This sealing face 79A is formed by 24 circularly constructed face portions 83A, which are disposed along two concentric circles K1, K2. In each face portion 83A, respectively one passage duct 85A discharges into a passage-duct outlet 87A. In the region of first sealing face 79A, valve-seat surface 79′A has an original average peak-to-valley height of 2.5 μm.

In contrast, valve seat 69B according to FIGS. 6a and 6b—again made from highly filled PEEK—has a first sealing face 79B, which is disposed on a raised sealing plateau 81B projecting relative to adjoining end-face regions 90B and is formed by an annular face 84B. In annular face 84B, ten passage ducts 85B discharge into ten circularly constructed passage-duct outlets 87B (disposed along an imaginary circle K3). In the region of first sealing face 79B, valve-seat surface 79′B has an original average peak-to-valley height of 2.5 μm.

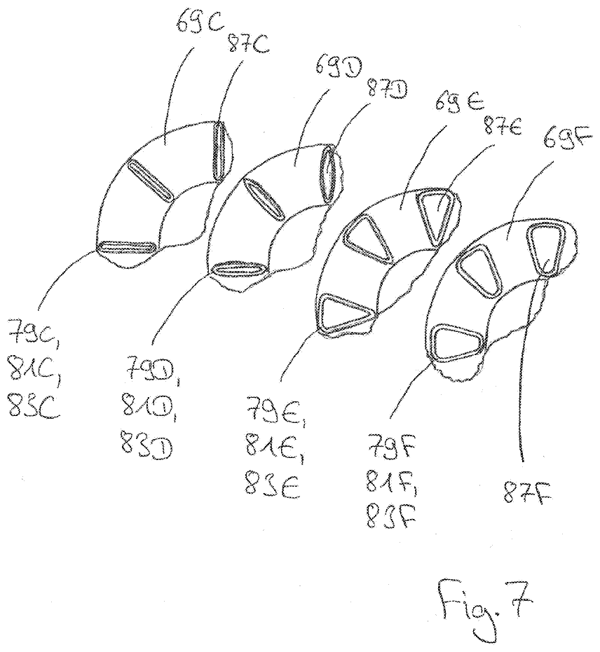

FIG. 7 shows axial sections of plan views of four different valve seats 69C, 69D, 69E and 69F of further embodiments of inventive fuel-cell system 1. Valve seats 69C to 69F respectively have a first sealing face 79C to 79F, which is disposed on a raised sealing plateau 81C to 81F. Sealing faces 79C to 79F are formed respectively by several face portions 83C to 83F, wherein these are constructed as elongated face portions 83C, oval face portions 83D, triangular face portions 83E and trapezoidal face portions 83F. In each face portion 83C to 83F, respectively one passage duct discharges into a passage-duct outlet 87C to 87F.

What is claimed is:

1. A fuel-cell system (1), comprising a fuel cell (3) having an anode chamber (7) and a cathode chamber (9) as well as, connected with a suction port (17) and with a pressure port (19) on the anode chamber (7), and serving for recirculation of an anode gas and metered charging of the anode chamber (7) with fuel gas, a jet-pump control-valve unit (5) having a jet pump (13) and a fuel-gas control valve (15), wherein the fuel-gas control valve (15) is connected fluidically between a fuel-gas source (25) and the jet pump (13), with the following features:
the fuel-gas control valve (15) comprises a valve seat (69) having a first sealing face (79) with at least two passage ducts (85) and a movable valve body (71) having a second sealing face (71);
the valve body (71) can be moved into a blocking position and a passing position by means of a valve-body actuator (73), wherein the first sealing face (79) and the second sealing face (82) bear on one another in a common sealing plane (E) and form a seal with one another,
while a stroke gap is formed between the first sealing face (79) and the second sealing face (82) in the passing position;
the first sealing face (79) and/or the second sealing face (82) is disposed on a raised sealing plateau (81);
a valve-seat surface in the region of the first sealing face (79) and/or a valve body surface (82) in the region of the second sealing face has/have an average peak-to-valley height of at most 1 μm;
the volume flow of a propulsion jet that can be generated by means of a propulsion nozzle (67) of the jet-pump control-valve unit (5) can be controlled by pulse-width-modulated urging of the valve-body actuator (73).

2. The fuel-cell system (1) of claim 1, wherein the first sealing face (79) is disposed on the raised sealing plateau (81) and is formed by at least one annular face (84B), in which at least two passage ducts (85B) discharge respectively into a passage-duct outlet (87B).

3. The fuel-cell system (1) of claim 2, wherein the passage-duct outlets (87) are of circular, oval, triangular or trapezoidal shape.

4. The fuel-cell system (1) of claim 2, wherein a reference circumference or a sum of reference circumferences of the at least one annular face (84B) is at least 60 times, preferably at least 80 times, particularly preferably at least 100 times larger than the stroke gap in passing position.

5. The fuel-cell system (1) of claim 1, wherein the first sealing face (79) is disposed on the raised sealing plateau (81) and is formed by at least two face portions (83), in which respectively one passage duct (85) discharges into a passage-duct outlet (87).

6. The fuel-cell system (1) of claim 5, wherein the at least two face portions (83) are of respectively circular, oval, triangular or trapezoidal shape.

7. The fuel-cell system (1) of claim 5, wherein a sum of the circumferences of the at least two face portions (83) is at least 150 times, preferably at least 250 times, particularly preferably at least 350 times larger than the stroke gap in passing position.

8. The fuel-cell system (1) of claim 1, wherein the valve-body actuator (73) comprises a flux concentrator (97) and an armature (99) coupled with the valve body (71), wherein, in the passing position, an air gap is formed between the armature (99) and the flux concentrator (97).

9. The fuel-cell system (1) of claim 1, wherein the valve body (71) or an armature (99) that may be provided on the valve-body actuator (73) is stopped in the passing position against at least one stop element (74), which is designed to be particularly elastic and/or noise-reducing.

10. The fuel-cell system (1) of claim 1, wherein the valve body (71) is able to move along a movement axis (A) into the blocking position and passing position, wherein the fuel gas can flow into the fuel-gas control valve (15) in a manner transverse to the movement axis and can flow out of the fuel-gas control valve (15) along the movement axis (A).

11. The fuel-cell system (1) of claim 2, wherein the propulsion nozzle (67) has a propulsion-nozzle outlet (67′), wherein the distance between the propulsion-nozzle outlet (67′) and the first sealing face (79) is at most 160 times, preferably at most 130 times, larger than the stroke gap when the fuel-gas control valve is open.

12. The fuel-cell system (1) of claim 1, wherein the valve body (71) is able to move along a movement axis (A) into the blocking position and the passing position, wherein the valve body (71) has, on its end face (91) turned toward the valve seat (69), at least one recess (95), constructed in particular as a blind hole (93) or annular groove, which is in fluidic communication with at least one inflow duct (96) extending transversely relative to the movement axis (A) as far as the periphery of the valve body (71).

13. The fuel-cell system (1) of claim 1, wherein the fuel-gas control valve (15) comprises a sleeve-like valve housing (59), which receives the valve seat (69), the valve body (71) and the valve-body actuator (73).

14. The fuel-cell system (1) of claim 13, wherein the valve body (71) is guided movably by the valve housing (59) along a movement axis (A) into the blocking position and the passing position and in the process is in contact with the valve housing (59) inside an annular contact region (K) of the valve housing (59),
wherein at least one inflow opening (109) extending transversely relative to the movement axis (A) is formed in a portion of the valve housing (59) starting from the contact region (K) and turned toward the valve seat (69), and
wherein at least one compensating opening (111) extending transversely relative to the movement axis (A) is formed in a portion of the valve housing (59) starting from the contact region (K) and turned away from the valve seat (69).

15. The fuel-cell system of claim 1, wherein the axial elevation of the sealing plateau (81) relative to the end-face parts, adjoining the sealing face (79, 82) in question, of the valve body (71) or valve seat (69), and therefore the axial height of a pressure chamber (D) formed between the mutually facing end faces (90, 91) of valve seat (69) and valve body (71) amounts to at least 1.5 times, preferably at least 3 times the valve-body stroke.
